(19) United States
(12) Patent Application Publication
(10) Pub. No.: US 2003/0228240 A1
(43) Pub. Date: Dec. 11, 2003

(54) Nozzle for matrix deposition

(76) Inventor: James L. Dwyer, Concord, MA (US)

Correspondence Address: Paul L. Sjoquist, 16365 Crystal Hills Circle, Lakeville, MN, 55044, US

(21) Appl. No.: 10/166,471

(22) Filed: Jun. 10, 2002

(51) Int. Cl. B01L 3/02

(52) U.S. Cl. 422/99; 422/100

(57) ABSTRACT

A spray nozzle for spraying a matrix reagent onto a foil carrier, for subsequent chromatographic analysis; the nozzle has an interior chamber for receiving a flow of the material sample into a capillary tube. The capillary tube has an open end concentric with gas flowing through the nozzle interior chamber, for causing the gas flow to atomize the material sample into a conical spray pattern. A pair of air jets are directed at the atomized conical spray pattern downstream from the capillary tube end, to flatten and elongate the atomized spray pattern for depositing on a collection medium.

### BACKGROUND OF THE INVENTION

This invention relates to a nozzle for spraying a matrix reagent on a surface, as a preparatory step toward analyzing the molecular weight(s) of a sample subsequently deposited on the deposited matrix layer. Such matrix reagents are employed in matrix assisted laser desorption ionization time of flight mass spectroscopy (MALDI TOF Mass spectroscopy), where they enable vaporization and ionization of the sample molecules. The invention relates to U.S. Pat. No. 5,772,964, issued Jun. 30, 1998, and entitled “Nozzle Arrangement for Collecting Components from a Fluid for Analysis,” by Dwyer and Prevost. The invention enables an improvement in the process described in U.S. Pat. No. 5,770,272, issued Jun. 23, 1998, and entitled “Matrix-Bearing Targets for MALDI Mass Spectrometry and Methods of Production Thereof,” by Biemann and Kochling. The Biemann/Kochling patent describes a process in which an inert planar surface is coated with a “matrix reagent”. Subsequently a “sample” is separated into its various components by liquid chromatography. The eluted components are spray deposited as a sample track onto the pre-prepared matrix plate, using an L-C transform instrument such as is described in the Dwyer and Prevost patent, and then the deposited sample on the matrix plate is analyzed by MALDI TOF Mass Spectroscopy.

The present invention is useful in the process step described above, relating to preliminarily coating a planar surface with a matrix reagent. It is desirable to develop a coating apparatus which can lay down an broad, uniform field of matrix reagent. It is known that fan spray guns produce broad, uniform spray patterns, but experimentation with conventional spray guns showed that they displayed a tendency to “run” if the spray head was too close to the foil. When the spray head was moved away to prevent this problem, very little material was deposited on the foil. Adhesion of that material which did deposit on the foil was poor. It is believed that the matrix solvent completely evaporated before spray droplets reached the foil surface, resulting in mainly a jet of dry particles, which did not stick to the foil surface. It was possible to only achieve very thin coats with poor adhesion. It was discovered that a unique design spray apparatus using lower gas/liquid ratios and heated gas streams will produce the desired matrix coating behavior. The apparatus uses a combination of a heated capillary nozzle and an ancillary fan spray to produce matrix-coated metal plates or foils.

### SUMMARY OF THE INVENTION

An apparatus for spraying MALDI matrix reagents on a collection foil for subsequent collection of samples eluting from liquid chromatography columns or other similar sample separation instrumentation. The apparatus comprises a nozzle for receiving a material entrained in a solvent, a capillary tube for passing the matrix reagents

through the nozzle to a spray tip, a source of heated gas providing a temperature-controlled gas flow into the nozzle and surrounding the capillary tube, the gas flow impinging on the matrix reagents as they leave the end of the tube, to atomize the matrix reagents into small spray particles, and an independent source of heated gas feeding through a pair of oppositely positioned gas jets downstream of the end of the tube, wherein the gas jets are directed at the atomized flow leaving the tube and cause the flow pattern to deform into a wider pattern, and to carry it toward the collection foil and deposit the matrix reagents on the foil.

### BRIEF DESCRIPTION OF THE DRAWINGS

FIG. 1 shows a simplified diagram of a prior art spray nozzle; and

FIG. 2 shows a simplified diagram of a spray nozzle of the present invention.

### DESCRIPTION OF THE PREFERRED EMBODIMENT

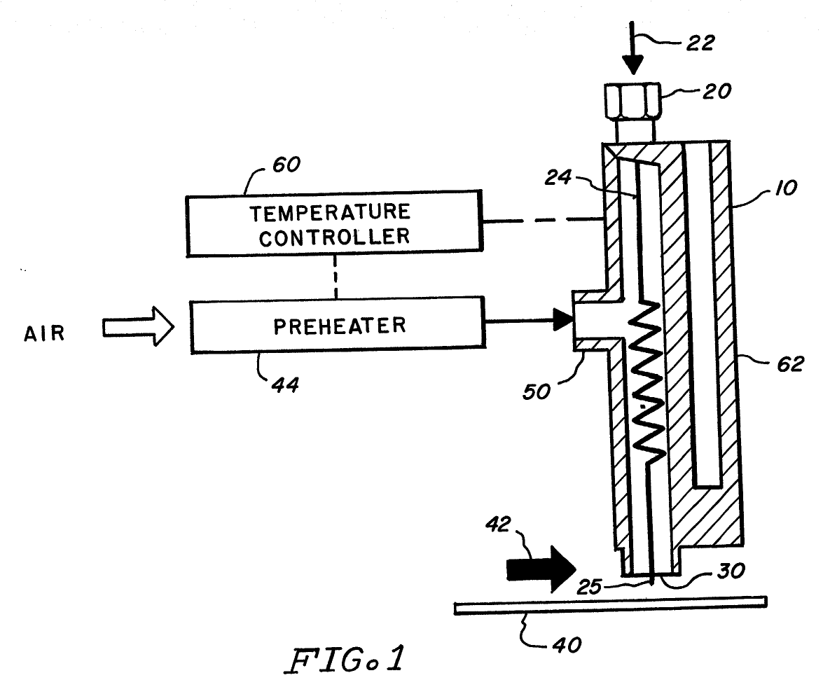

Referring first to FIG. 1, prior art nozzle of the type described in U.S. Pat. No. 5,772,964 is shown. A nozzle body 10 has a solvent/sample inlet tube 20 which receives a flow of material sample dissolved in a solvent, in the flow direction indicated by arrow 22. The material is passed through a capillary tube 24 and is emitted from the capillary tube 24 through its end 25. The capillary tube is typically sized between 50 and 300 micro-meters, and is typically 30 cm. in length. As the material leaves the end of the capillary tube it is broken into droplets by the flow of the pressurized air through the nozzle body 10, and therefore becomes atomized at the tip 25 of the capillary tube 24. The orifice in the nozzle outlet 30 surrounding the capillary tip 25 forms the resulting jet of atomized droplets into a narrow conical spray pattern.

The sprayed material is deposited in a narrow pattern on a collection foil 40 which has previously been coated with matrix reagent, and which is translated in a direction into and out of the paper while the material is being sprayed. Between spray tracks, the foil 40 is repositioned in the direction of arrow 42, so the next subsequent spray track is deposited along a track parallel to the first track. This activity is continued until the foil is covered with the desired number of tracks for subsequent processing, and it is then removed and a new foil placed under the nozzle body 10.

A source of air or other gas such as nitrogen is fed into a preheater 44, where it is heated to a predetermined temperature and then passed into the interior of spray body 10 through inlet 50. The temperature of the preheated gas is controlled by a temperature controller 60, which monitors the temperature of the heated gas immediately above the nozzle outlet 30. A block heater 62 is mounted in the body 10, and its temperature is also controlled by the controller 60, so that the temperature of the sprayed material is very closely controlled.

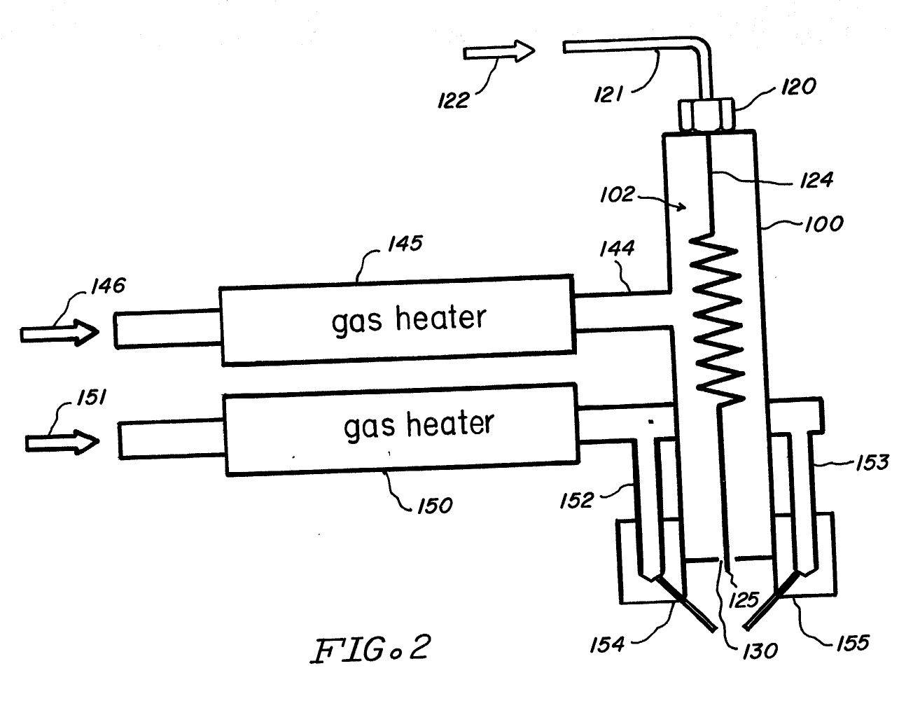

FIG. 2 shows a simplified diagram of the present invention, with the improvements over the prior art nozzle of FIG. 1. The nozzle of FIG. 2 is designed to spray matrix and solvent, whereas the nozzle of FIG. 1 is designed to spray a solvent and sample. The nozzle of FIG. 2 also has a block heater in the nozzle body comparable to heater 62 (see FIG. 1) which serves the purpose of “buffering” or smoothing the gas temperature.

A nozzle body 100 has an interior chamber 102 and a number of inlet and outlet openings. An inlet 120 is connected to receive a flow of matrix reagent via inlet tube 121, in a flow direction shown by arrow 122. The material is passed into a capillary tube 124 which passes through chamber 102 and, at least along part of its distance, is coiled along a helical path. Capillary tube 124 has an outlet end 125 through which the matrix reagent is ejected.

A second inlet 144 into nozzle body 100 receives a flow of heated gas through a gas heater 145, in the flow direction shown by arrow 146. This heated gas flows through the chamber 102 and out the nozzle body outlet 130, where it shears off droplets of the matrix reagent being ejected through end 125 and forms the ejected reagent into an atomized spray having a conical pattern. The heated gas also heats the chamber 102 and the capillary tube 124, as well as the matrix reagent flowing through the capillary tube 124.

A further source of independently controllable gas is passed through a heater 150 in the flow direction shown by arrow 151. This heated gas is passed through conduits 152 and 153 to a pair of respective spray jets 154 and 155, placed on respective sides of the spray nozzle outlet. These spray jets are angled obliquely to the axis of the emitted spray, and are positioned to impinge on the conical spray pattern emitted from the nozzle, and to deform the pattern into a flattened, elongated pattern. The flattened, elongated matrix pattern is then deposited on a collector foil for subsequent use as described herein.

The air jets 154 and 155 are, in the preferred embodiment, angled at 45 degrees relative to the axis of the emitted conical spray from the capillary tube 124, and are positioned several centimeters above the foil collection material. An oval pattern, approximately 30 mm wide along its major axis and 8 mm wide along its minor axis is deposited on the foil. The thickness of the applied spray pattern is not perfectly uniform; the deposit is heaviest at the center and tapers off at the edges. Thickness uniformity is increased by making two or three overlapping passes.

In one experiment, a material sample comprised of a matrix of a-cyano cinnamic acid and a solvent of 70% acetonitrile and 30% ethanol was sprayed through the nozzle. The gas passing through inlet 144 was maintained at a pressure of 5 psi, and a temperature of 45° C.; the gas passing through conduits 152 and 153 was maintained at a pressure of 35 psi and a temperature of 30° C. The flow rate of the material sample through the capillary tube 124 was controlled at 1 milliliter per minute (ml/min), and the collection foil was moved at 50 mm/min. This experiment produced a continuous adherent film of uniform distribution on the foil collector, and the coating rate was greatly improved over the prior art.

The nozzle tip is designed such that the capillary tip is centered within an orifice in the nozzle tip. The sheath gas flows concentric to the capillary tube outlet, and its relatively high velocity shears emergent liquid off the capillary tip, producing a fine nebulized spray of small diameter droplets. The sensible heat of the sheath gas provides evaporative energy for the liquid spray droplets. This is a sensitive control parameter, as we have observed changes in deposition characteristics by simply changing sheath gas temperature by as little as 1° C. Sheath gas temperature may be sensed and controlled via a temperature probe situated in the nozzle tip.

Experimentation has shown that successful spray coating is achieved when almost, but not quite all, of the matrix reagent evaporates before the matrix reagent impacts the foil. The matrix chemicals are low molecular weight readily crystallizable solutes, and are unlike polymeric paints applied in spray applications, because a solution of matrix reagent will not appreciably increase viscosity as solvent is evaporated. It will remain a low viscosity solution right up to saturation; and as such will tend to run under the pneumatic forces of the sheath gas stream impinging on the foil surface, except that the hot sheath gas, properly applied, will evaporate most of the solvent during the droplet's flight to the foil. Therefore, careful adjustment of sheath gas temperature is a critical success factor in the deposition of uniform, coherent and adherent matrix coatings.

Electron micrographs of the matrix coating applied with the present invention reveal a mat of microscopic, irregularly shaped granules of matrix. The granules are discrete, but are adhered to one another. It is believed that the following process steps occur during matrix deposition:

1) Droplets of matrix solution are formed while still in the lower section of the capillary; some, but not all, of the solvent is evaporated, and the droplets are liquid concentrates of matrix.

2) As the droplets leave the nozzle tip, the solvent continues to evaporate, resulting in still higher concentration of the matrix in each droplet.

3) At some point the droplets become saturated, and matrix solid precipitates within the droplets; although the matrix chemicals are inherently crystalline, the very short time of evaporation precludes orderly crystal growth.

4) The droplets impact the foil surface as a series of “paste” or “mud” particles; the small amount of remaining solvent promotes adhesion of the “mudball” to the foil surface and/or previously deposited matrix particles.

5) Over the period of several seconds, all residual solvent evaporates, leaving a coating of co-adhered, microscopic, matrix granules.

The present invention may be embodied in other specific forms without departing from the spirit or essential attributes thereof; and it is, therefore, desired that the present embodiment be considered in all respects as illustrative and not restrictive, reference being made to the appended claims rather than to the foregoing description to indicate the scope of the invention.

What is claimed is:

1. An apparatus for spraying matrix reagent onto a collection medium in a uniform, relatively wide pattern, comprising:
a. a nozzle having an outer body and an interior chamber, said nozzle outer body having means for receiving a flow of said matrix reagent into a capillary tube in said interior, said capillary tube having a lower open end for ejecting said flow of said component;
b. a source of gas and a first heater connected to said source of gas, and said first heater having an inlet into said interior chamber, said nozzle body having a concentric opening about said capillary tube open end; whereby said gas can flow through said first heater and into said chamber, and said gas flow atomizes material ejected from said capillary tube open end and carries said atomized fluid along an axis;
c. a source of gas and a second heater connected to said source of gas, and a pair of gas conduits extending from said second heater to a region outside said nozzle body proximate said capillary tube open end; and
d. an air jet in each of said gas conduits, each air jet angled obliquely toward said axis to flatten the pattern of atomized material carried along said axis.

2. The apparatus of claim 1, wherein said air jets are each respectively angled at substantially 45° relative to said axis.

3. The apparatus of claim 2, further comprising means for controlling the temperature and flow rate of said gas in said conduits and independent means for controlling the temperature and flow rate of said gas in said interior nozzle chamber.

4. The apparatus of claim 3, wherein said means for controlling the temperature of said gas in said conduits is independently adjustable relative to said means for controlling the temperature of said gas in said chamber.

5. The apparatus of claim 4 wherein the pressure of said gas in said chamber is substantially about 5 psi, and the temperature of said gas is substantially about 45° C.

6. The apparatus of claim 5 wherein the pressure of said gas in said conduits is substantially about 35 psi, and the temperature of said gas is substantially about 30° C.

7. An apparatus for spraying matrix reagent onto a collection medium, comprising:
a. a nozzle body having an interior chamber running from an inlet end to an outlet end, said chamber having a narrowing taper towards said outlet end;
b. a capillary tube running along an axis through said chamber from said inlet end to said outlet end, said tube having means for connection to a source of matrix reagent at the inlet end, and said tube outlet end being proximately centered in said chamber outlet end;
c. an opening through a wall of said chamber, and a fitting attached to said opening for the passage of gas therethrough;
d. a first source of gas and a first heater connected thereto; said heater having an outlet connected to said fitting;
e. a pair of diametrically opposed gas jets positioned adjacent said chamber outer end, said jets being obliquely angled relative to the axis of said capillary tube; and
f. a second source of gas and a second heater connected thereto; said second heater having an outlet connected to said pair of jets.

8. The apparatus of claim 7, wherein the angle of each of said jets is substantially 45° relative to said axis.

9. The apparatus of claim 8, further comprising independent control means for regulating the temperature and flow rate of each of said first and second gas sources and heaters.
